(19) United States
(12) Patent Application Publication
(10) Pub. No.: US 2013/0265347 A1
(43) Pub. Date: Oct. 10, 2013

(54) DISPLAY APPARATUS AND METHOD OF DRIVING THE SAME

(71) Applicant: SAMSUNG DISPLAY CO., LTD., Yongin-City (KR)

(72) Inventors: Hyeon Seok BAE, Asan-si (KR); Jae-Yong KWON, Yecheon-gun (KR); Duckyong AHN, Suwon-si (KR); Jaeeun UM, Asan-si (KR); Kwangyoul LEE, Asan-si (KR); Sangchul LEE, Yongin-si (KR); Heung-Sik TAE, Bucheon-si (KR)

(73) Assignee: SAMSUNG DISPLAY CO., LTD., Yongin-City (KR)

(21) Appl. No.: 13/786,301

(22) Filed: Mar. 5, 2013

(30) Foreign Application Priority Data
Apr. 10, 2012 (KR) 10-2012-0037501

(51) Int. Cl. G09G 5/10

(52) U.S. Cl. CPC G09G 5/10
USPC 345/691

(57) ABSTRACT

A display apparatus a display panel that includes pixels arranged in rows by columns, which are connected to gate lines and data lines, a timing controller that outputs control signals and data signals, a gate driver that applies gate signals to the pixels through the gate lines, and a data driver that receives the data signals and applies data voltages corresponding to the data signals to the pixels through the data lines. The timing controller checks whether a pattern of data values corresponds to a checker pattern, in which black and white patterns are alternately repeated in a row direction and a column direction, checks whether an area of the checker pattern is equal to or greater than a predetermined area of the display panel, and compensates for the data signals in accordance with the checked result.

### CROSS-REFERENCE TO RELATED APPLICATION

This U.S. non-provisional patent application claims priority under 35 U.S.C. §119 of Korean Patent Application No. 10-2012-0037501, filed on Apr. 10, 2012, the contents of which are hereby incorporated by reference.

### BACKGROUND

1. Field of disclosure

The present disclosure relates to a display apparatus and a method of driving the same.

More particularly, the present disclosure relates to a display apparatus capable of improving a color distortion and a method of driving the display apparatus.

2. Description of the Related Art

In general, a liquid crystal display is operated in an inversion driving scheme so as to prevent deterioration of liquid crystal. For instance, a pixel alternately receives two gray scale voltages, which are complementary to each other with respect to the same pixel data signal and with reference to a common voltage, at every frame. In the inversion driving scheme, desired images are displayed exactly as intended only when a voltage difference between one of the two gray scale voltages and the common voltage is equal to a voltage difference between the other one of the two gray scale voltages and the common voltage.

However, the electric potential of the common voltage varies due to a coupling between the pixel data signal and the common voltage when the image is displayed on the liquid crystal display. Because of the variation of the common voltage, the voltage difference between one of the two gray scale voltages and the common voltage becomes different from the voltage difference between the other one of the two gray scale voltages and the common voltage. As a result, crosstalk and color distortion occur, thereby causing deterioration in display quality.

### SUMMARY

The present disclosure provides a display apparatus capable of improving a color distortion.

The present disclosure provides a method of driving the display apparatus.

In one aspect, a display apparatus includes a display panel that includes a plurality of pixels arranged in rows by columns, which are connected to a plurality of gate lines and a plurality of data lines crossing the gate lines, a timing controller that outputs control signals and data signals, a gate driver that applies gate signals to the pixels through the gate lines in response to the control signals, and a data driver that receives the data signals and applies data voltages corresponding to the data signals to the pixels through the data lines in response to the control signals. The timing controller checks whether a pattern of data values provided from an external source corresponds to a checker pattern, in which black and white patterns are alternately repeated in a row direction and a column direction, checks whether an area of the checker pattern is equal to or greater than a predetermined area of the display panel, and compensates for the data signals in accordance with the checked result.

Each of the pixels includes a first sub-pixel, a second sub-pixel, and a third sub-pixel, and the first, second, and third sub-pixels are repeatedly arranged in a direction in which the data lines extend.

The sub-pixels arranged in odd-numbered rows and connected to odd-numbered gate lines of the gate lines are electrically connected to the data lines disposed at a left side thereof, and the sub-pixels arranged in even-numbered rows and connected to even-numbered gate lines of the gate lines are electrically connected to the data lines disposed at a right side thereof.

The data lines alternately receive the data voltages having different polarities from each other and the sub-pixels are driven in a dot-inversion driving scheme.

The timing controller includes a pattern comparator that receives the data values and checks the pattern of the data values, a first logic circuit that outputs a first logic signal in response to the checked result from the pattern comparator when the pattern of the data values corresponds to the checker pattern, a counter that counts the area of the checker pattern in response to the first logic signal, a second logic circuit that outputs a second logic signal in response to the inspected result from the counter when the area of the checker pattern is equal to or greater than the predetermined area of the display panel, and a data signal compensator that compensates for the data signals in response to the second logic signal.

The pattern comparator includes a first comparator that compares, for each pixel, the data values provided to the sub-pixels in the pixel with each other; a second comparator that compares a first absolute value of the data values provided to the first sub-pixel of a first pixel and the second sub-pixel of a second pixel adjacent to each other, the first sub-pixel of the first pixel and the second sub-pixel of the second pixel connected to a same data line, or the second sub-pixel of the second pixel and third sub-pixel of the first pixel, the second and third pixels connected to the same data line, with a first difference value; and a third comparator that compares a second absolute value of the data values provided to a first sub-pixel of a third pixel in a row below and adjacent to the second pixel and the third sub-pixel of the second pixel, the first sub-pixel of the third pixel and the third sub-pixel of the second pixel connected to the same data line, with a second difference value.

The first logic circuit includes a three-input AND gate to respectively receive compared results from the first, second, and third comparators, and the three-input AND gate outputs the first logic signal having a high level in response to the compared results from the first, second, and third comparators when the data values applied to the sub-pixels of each pixel are the same, the first absolute value is equal to or greater than the first difference value, and the second absolute value is equal to or smaller than the second difference value. The first difference value is set to a minimum value of the first absolute value that causes a color distortion, and the second difference value is set to a maximum value of the second absolute value that causes the color distortion.

The first absolute value is a gray scale difference value between the first sub-pixel of the first pixel and the second sub-pixel of the second pixel adjacent to each other, the first sub-pixel of the first pixel and the second sub-pixel of the second pixel connected to a same data line, or the second sub-pixel of the second pixel and third sub-pixel of the first pixel, the second and third pixels connected to the same data line.

The second absolute value is a gray scale difference value between the first sub-pixel of the third pixel in a row below and adjacent to the second pixel and the third sub-pixel of the second pixel, the first sub-pixel of the third pixel and the third sub-pixel of the second pixel connected to the same data line.

The counter includes a first counter that receives the data values and counts a number of rows of the pattern of the data values in response to the first logic signal, and a second counter that receives the data values and counts a number of columns of the pattern of the data values in response to the first logic signal.

The second logic circuit includes a two-input AND gate to respectively receive the counted results from the first and second counters, and the two-input AND gate outputs the second logic signal having a high level in response to the value of the counted results of each of the first and second counters when the counted value of the row is equal to or greater than M and the counted value of the column is equal to or greater than N.

The M corresponds to two-thirds of a number of the data lines and the N corresponds to two-thirds of a number of the gate lines.

The sub-pixels receive a common voltage and displays a gray scale corresponding to a gray scale value defined by a level difference between the common voltage and the data voltage, and the data signal compensator compensates for the data signals to allow the data values applied to the first, second, and third sub-pixels to be the same.

The gate driver includes a first gate driver connected to odd-numbered gate lines of the gate lines and outputs the gate signals in response to the control signals and a second gate driver connected to even-numbered gate lines of the gate lines and outputs the gate signals in response to the control signals. The first and second gate drivers are mounted on both left and right end portions of the display panel and formed in amorphous silicon TFT gate driver circuit.

In another aspect a method of driving a display apparatus that includes a display panel includes a plurality of pixels arranged in rows by columns, the pixels being connected to a plurality of gate lines and a plurality of data lines crossing the gate lines, the method including receiving data values; inspecting a pattern of the data values; inspecting whether the pattern of the data values corresponds to a checker pattern, in which black and white patterns are alternately repeated in a row direction and a column direction; measuring an area of the checker pattern; compensating for data signals used to generate data voltages applied to the pixels when the area of the checker pattern is equal to or greater than a predetermined area of the display panel; and applying the data voltages corresponding to the compensated data signals to the pixels having the checker pattern through the data lines in response to gate signals provided through the gate lines.

According to the above, the display apparatus compensates for the data values, and thus the degree of color distortion may be minimized to improve the quality of the display.

### BRIEF DESCRIPTION OF THE DRAWINGS

The above and other advantages will become readily apparent by reference to the following detailed description when considered in conjunction with the accompanying drawings wherein:

FIG. 1 is a block diagram showing a display apparatus according to an exemplary embodiment;

FIG. 2 is a view showing an arrangement of pixels of a display panel shown in FIG. 1;

FIG. 3 is a block diagram showing a timing controller shown in FIG. 1;

FIG. 4 is a view showing a specific pattern of pixels that causes a color distortion of the display panel shown in FIG. 2;

FIGS. 5 to 7 are timing diagrams explaining a level variation of a common voltage and a color distortion, which are caused by the specific pattern of the pixels shown in FIG. 4;

FIG. 8 is a timing diagram showing a voltage level of a pixel applied with a data voltage compensated by a signal compensator shown in FIG. 3; and

FIG. 9 is a flowchart explaining a method of driving a display apparatus according to an exemplary embodiment.

### DETAILED DESCRIPTION

Hereinafter, exemplary embodiments will be explained in detail with reference to the accompanying drawings.

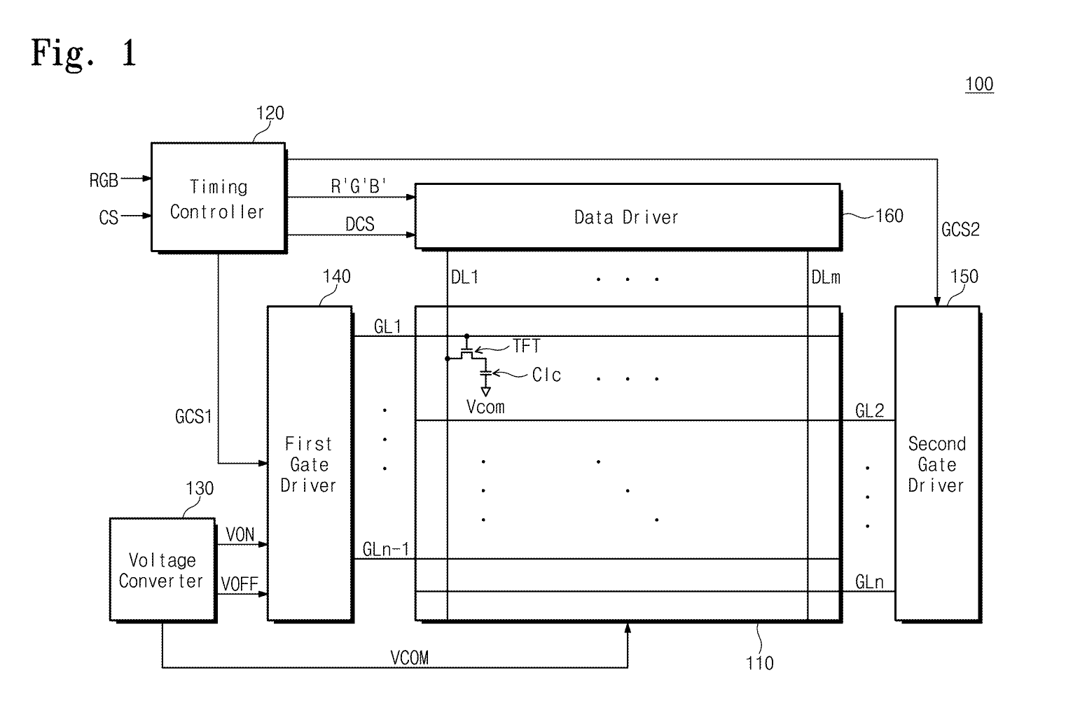

FIG. 1 is a block diagram showing a display apparatus according to an exemplary embodiment.

Referring to FIG. 1, a display apparatus 100 includes a display panel 110, a timing controller 120, a voltage converter 130, a first gate driver 140, a second gate driver 150, and a data driver 160.

The display panel 110 includes a plurality of gate lines GL1 to GLn, a plurality of data lines DL1 to DLm crossing the gate lines GL1 to GLn, and a plurality of pixels arranged in areas defined in association with the gate lines GL1 to GLn and the data lines DL1 to DLm.

The pixels are arranged in a matrix form of n rows by m columns.

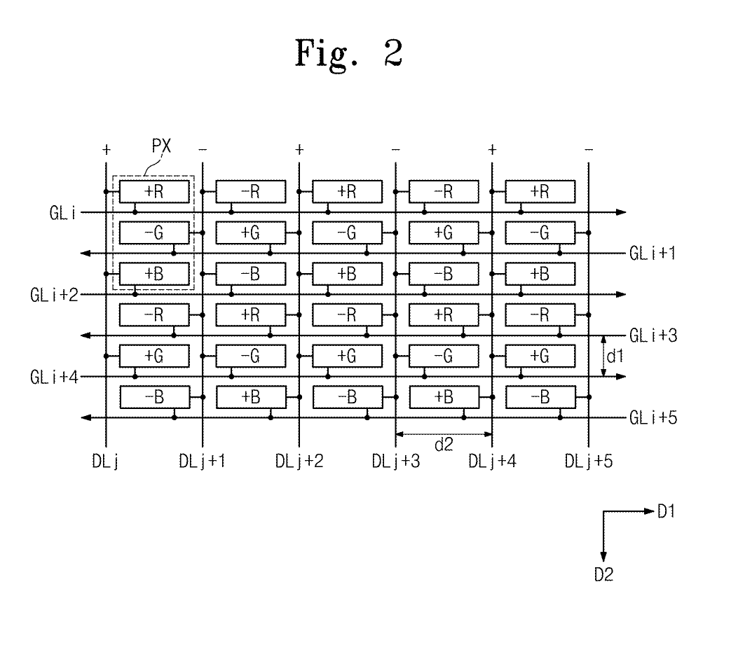

Each pixel of the display panel 110 includes a plurality of sub-pixels. For instance, each pixel includes a first sub-pixel, a second sub-pixel, and a third sub-pixel, and the first, second, and third pixels are repeatedly arranged in a direction in which the data lines DL1 to DLm extend. The sub-pixels are arranged in a matrix configuration. The arrangement of the sub-pixels will be described in detail with reference to FIG. 2.

In addition, each pixel includes a liquid crystal capacitor Clc and a thin film transistor TFT. The TFT is connected to a corresponding gate line of the gate lines GL1 to GLn, a corresponding data line of the data lines DL1 to DLm, and the liquid crystal capacitor Clc. The thin film transistor TFT includes a gate electrode connected to the corresponding gate line, a source electrode connected to the corresponding data line, and a drain electrode connected to the liquid crystal capacitor Clc and a pixel electrode (not shown). The display panel 110 includes a common electrode (not shown) facing the sub-pixels and receiving a common voltage VCOM.

The thin film transistor TFT applies a data voltage, which is provided through the corresponding data line, to the liquid crystal capacitor Clc in response to a gate signal provided through the corresponding gate line. The liquid crystal capacitor Clc is charged with a pixel voltage corresponding to the data voltage (or a gray scale voltage).

The timing controller 120 receives an image signal RGB and a control signal CS from an external source, e.g., a system board. Although not shown in FIG. 1, the control signal CS includes a horizontal synchronization signal H_SYNC, a vertical synchronization signal V_SYNC, a main clock signal MCLK, and a data enable signal DE.

The timing controller 120 generates a data control signal DCS, a first gate control signal GCS1, and a second gate control signal GCS2 in response to the control signal CS. The data control signal DCS is used to control an operation timing of the data driver 160.

The first gate control signal GCS1 is used to control an operation timing of the first gate driver 140, and the second gate control signal GCS2 is used to control an operation timing of the second gate driver 150.

Although not shown in FIG. 1, the data control signal DCS includes a latch signal TP, a horizontal start signal STH, a polarity control signal POL, and a clock signal HCLK. In addition, each of the first and second gate control signals includes a vertical start signal STV, a gate clock signal CPV, and an output enable signal OE.

The timing controller 120 applies the data control signal DCS, the first gate control signal GCS1, and the second gate control signal GCS2 to, respectively, the data driver 160, the first gate driver 140, and the second gate driver 150.

The timing controller 120 provides image signals RGB, which are provided from the external source to be displayed by the pixels, to the data driver 160 as data signals R′G′B′.

The timing controller 120 inspects a pattern of the image signals RGB before providing the data signals R′G′B′ to the data driver 160. In a case in which the pattern of the image signals RGB matches a condition that causes a color distortion, the timing controller 120 compensates for the data signals R′G′B′. In a case that the pattern of the image signals RGB does not match a condition that causes a color distortion, the timing controller 120 does not compensate for the data signals R′G′B′. The inspection of the pattern of the image signals RGB will be described in detail below.

The voltage converter 130 converts a direct current source voltage VDD (not shown) to generate a gate-on voltage VON, a gate-off voltage VOFF, and the common voltage VCOM. The voltage converter 130 applies the gate-on voltage VON and the gate-off voltage VOFF to the first and second gate drivers 140 and 150 and applies the common voltage VCOM to the common electrode (not shown) of the display panel 110. The voltage converter 130 may be, but is not limited to, a DC/DC converter.

The first and second gate drivers 140 and 150 form a gate driver, and the gate driver sequentially applies the gate signals to the gate lines GL1 to GLn. As a result, the gate signals are sequentially applied to the sub-pixels, and the sub-pixels are driven in the unit of TOW.

Odd-numbered gate lines GL1, GL3, . . . , GLn-1 of the gate lines GL1 to GLn are connected to the first gate driver 140 and even-numbered gate lines GL2, GL4, . . . , GLn of the gate lines GL1 to GLn are connected to the second gate driver 150. The gate lines GL1 to GLn are sequentially applied with the gate signals provided from the first and second gate drivers 140 and 150.

The first gate driver 140 outputs the gate signals in response to the first gate control signal GCS1 from the timing controller 120. The second gate driver 150 outputs the gate signals in response to the second gate control signal GCS2 from the timing controller 120.

The first and second gate drivers 140 and 150 may be mounted on both end portions of the display panel 110 and formed in ASG (amorphous silicon TFT gate driver circuit).

The data driver 160 converts the data signals R′G′B′ to analog data voltages in response to the data control signal DCS from the timing controller 120. The data lines DL1 to DLm are connected to the data driver 160 to receive the data voltages. The data voltages are applied to the sub-pixels through the data lines DL1 to DLm.

Accordingly, the thin film transistor TFT of the sub-pixel connected to the gate line is turned on, and the data voltage is provided to the sub-pixel by the turned-on thin film transistors TFT. The data voltage is applied to the liquid crystal capacitor Clc of the sub-pixel through the thin film transistor TFT. The pixel voltage corresponding to a level difference between the common voltage VCOM applied to the common electrode and the data voltage applied to the sub-pixel is charged in the liquid crystal capacitor Clc, and the sub-pixel displays a gray scale corresponding to the pixel voltage.

Although not shown in FIG. 1, the display apparatus 100 may include a backlight unit to provide light to the display panel 110. The backlight unit includes a light source, such as a fluorescent lamp or a light emitting diode, that emits light.

FIG. 2 is a view showing an arrangement of pixels of a display panel shown in FIG. 1.

FIG. 2 shows a portion of the pixels of the display panel 110 shown in FIG. 1.

Referring to FIG. 2, a plurality of pixel areas is defined on the display panel 110 in a matrix form by the gate lines GLi, GLi+1, GLi+2, GLi+3, GLi+4, and GLi+5 and the data lines DLj, DLj+1, DLj+2, DLj+3, DLj+4, and DLj+5. In the present exemplary embodiment, i is an odd integer larger than zero and smaller than n, and j is an odd integer larger than zero and smaller than m.

Red R, green G, and blue B sub-pixels are repeatedly arranged in the pixel areas along the direction, in which the data lines extend, e.g., a vertical direction or a column direction. However, the arrangement of the sub-pixels R, G, and B should not be limited thereto or thereby. That is, the sub-pixels R, G, and B may be arranged in the order of the green G, blue B, and red R sub-pixels or of the blue B, red R, and green G sub-pixels.

The sub-pixels R, G, and B may be respectively referred to as first, second, and third sub-pixel in accordance with the arrangement order. For instance, the red sub-pixel R, the green sub-pixel G, and the blue sub-pixel B may be defined, respectively, as the first sub-pixel, the second sub-pixel, and the third sub-pixel.

Although not shown in FIG. 2, color filters, which have colors respectively corresponding to red, green, and blue colors, are disposed above the red, green, and blue sub-pixels R, G, and B, respectively. A viewer may perceive the colors (as mixed via the viewer's human perception) from the light passing through the color filters.

Each pixel area has a rectangular shape. That is, a first distance dl between two gate lines adjacent to each other is narrower than a second distance d2 between two data lines adjacent to each other. As a result, each pixel area has a length in a first direction D1 longer than a length in a second direction D2.

As an exemplary embodiment, the second distance d2 is three times larger than the first distance dl. Accordingly, for a predetermined display area, a total number of the gate lines is more than three times as much as that of the data lines. As a result, for the predetermined display area, the number of the data lines is reduced to one-third of that when the length of the pixel areas in the second direction D2 is three times longer than the length of the pixel areas in the first direction D1.

As described in FIG. 1, among the gate lines GLi, GLi+1, GLi+3, GLi+3, GLi+4, and GLi+5, odd-numbered gate lines GLi, GLi+2, and GLi+4 are connected to the first gate driver 140, and even-numbered gate lines GLi+1, GLi+3, and GLi+5 are connected to the second gate driver 150. The data lines DLj, DLj+1, DLj+2, DLj+3, DLj+4, and DLj+5 are connected to the data driver 160.

The sub-pixels arranged in odd-numbered rows and connected to the odd-numbered gate lines GLi, GLi+2, and GLi+4 are electrically connected to the data lines disposed at a left side thereof. In detail, the red sub-pixels R arranged in a first row are electrically connected to the data lines DLj, DLj+l, DLj+2, DLj+3, and DLj+4, respectively, each of which is disposed at the left side of a corresponding red sub-pixel of the red sub-pixels R. With reference to the thin film transistor shown in FIG. 1, the thin film transistors of the sub-pixels arranged in the odd-numbered rows are electrically connected to the data lines DLj, DLj+1, DLj+2, DLj+3, and DLj+4 disposed at the left side thereof.

The sub-pixels arranged in even-numbered rows and connected to the even-numbered gate lines GLi+1, GLi+3, and GLi+5 are electrically connected to the data lines disposed at a right side thereof. In detail, the green sub-pixels G arranged in a second row are electrically connected to the data lines DLj+1, DLj+2, DLj+3, DLj+4, and DLj+5, respectively, each of which is disposed at the right side of a corresponding green sub-pixel of the green sub-pixels G. With reference to the thin film transistor shown in FIG. 1, the thin film transistors of the sub-pixels arranged in the even-numbered rows are electrically connected to the data lines DLj+1, DLj+2, DLj+3, DLj+4, and DLj+5 disposed at the right side thereof

Thus, for a column of sub-pixels, the electrical connection to a data line alternates between the data line on the left of the column and the data line on the right of the column each sub-pixel down the column.

In addition, each of the data lines DLj, DLj+1, DLj+2, DLj+3, DLj+4, and DLj+5 is alternately applied with data voltages that have different polarities from each other. That is, when positive (+) polarity data signals are applied to the odd-numbered data lines DLj, DLj+2, and DLj+4, negative (−) polarity data signals are applied to the even-numbered data lines DLj+1, DLj+3, and DLj+5. Thus, the display apparatus 100 may be operated in a dot-inversion driving scheme.

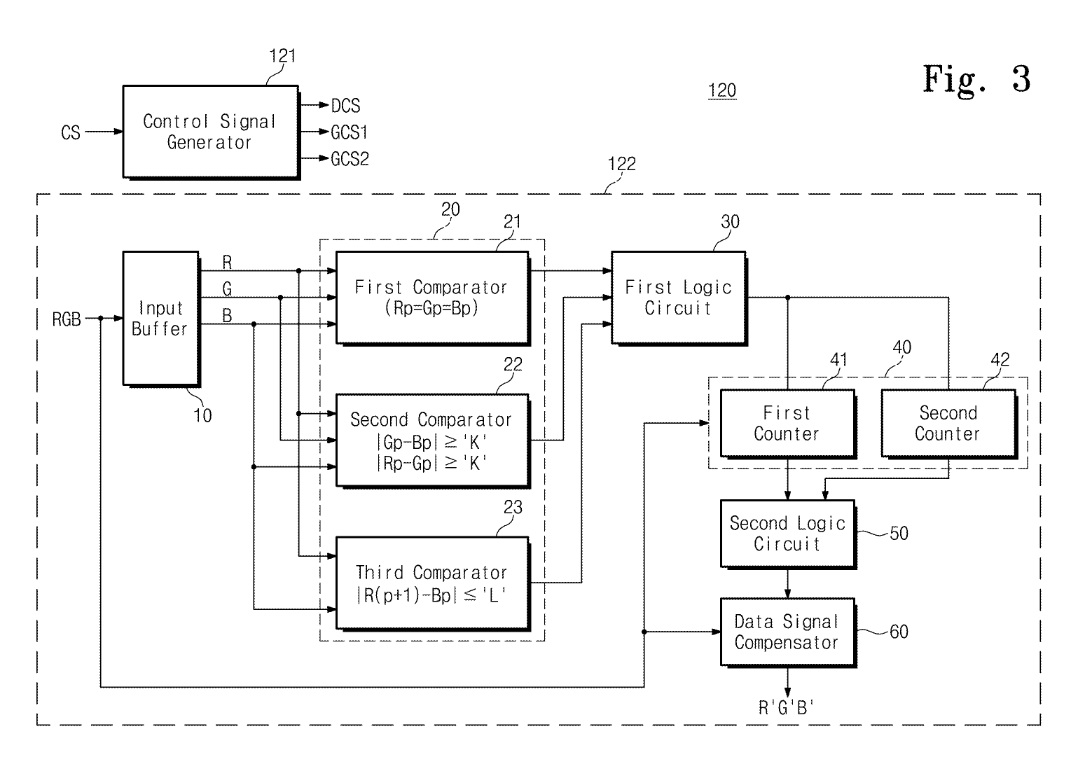

FIG. 3 is a block diagram showing a timing controller shown in FIG. 1.

Referring to FIG. 3, the timing controller 120 includes a control signal generator 121 and a data compensator 122.

The control signal generator 121 generates the data control signal DCS, the first gate control signal GCS1, and the second gate control signal GCS2 in response to the control signal CS. The data control signal is applied to the data driver 160, and the first and second gate control signals GCS1 and GCS2 are applied to the first and second drivers 140 and 150, respectively.

The data compensator 122 provides the image signals RGB to the data driver 160 as the data signals R′G′B′. The data compensator 122 inspects the pattern of the image signals RGB before providing the data signals R′G′B′ to the data driver 160. In the case in which the pattern of the image signals RGB matches a condition that causes a color distortion, the timing controller 120 compensates for the data signals R′G′B′. In the case that the pattern of the image signals RGB does not match a condition that causes the color distortion, the timing controller 120 does not compensate for the data signals R′G′B′.

The data compensator 122 includes an input buffer 10, a pattern comparator 20, a first logic circuit 30, a counter 40, a second logic circuit 50, and a data signal compensator 60.

The pattern comparator 20 includes a first comparator 21, a second comparator 22, and a third comparator 23. The counter 40 includes a first counter 41 and a second counter 42.

The input buffer 10 of the data compensator 122 provides the image signals RGB to each of the first, second, and third comparators 21, 22, and 23 of the pattern comparator 20.

The image signals RGB are provided to the data driver 160 as the data signals R′G′B′ and the data driver 160 provides the data voltages corresponding to the data signals R′G′B′ to the pixels. Therefore, the image signals RGB may be defined as data values to be provided to the pixels.

For each pixel, the first comparator 21 compares the patterns of the image signals RGB, which are to be applied to the sub-pixels of the pixel, with each other. For example, in a case in which the data values to be provided to the sub-pixels of the pixel are the same, the first comparator 21 outputs a high level signal, and in a case that the data values to be provided to the sub-pixels of the pixel are different from each other, the first comparator 21 outputs a low level signal. In other words, the first comparator 21 outputs the high level signal when all the sub-pixels in a pixel are to display a black gray scale or a white gray scale.

The second comparator 22 checks whether a first absolute value of a difference between the data values, which are to be applied to the first and second sub-pixels adjacent to each other among the sub-pixels of two adjacent pixels and are connected to the same data line, is equal to or greater than a first difference value K. In addition, the second comparator 22 checks whether a first absolute value of a difference between the data values, which are applied to the second and third sub-pixels adjacent to each other among the sub-pixels of two adjacent pixels and are connected to the same data line, is equal to or greater than a first difference value K.

The first difference value K may be set to a minimum value of the first absolute value that is required to cause the color distortion. In addition, the first difference value K may be defined by a predetermined gray scale value. The first absolute value may be defined by a gray scale difference value between the first and second sub-pixels or between the second and third sub-pixels, which are adjacent to each other and connected to the same data line. The second comparator 22 outputs the high level signal when either of the first absolute value is equal to or greater than the first difference value K.

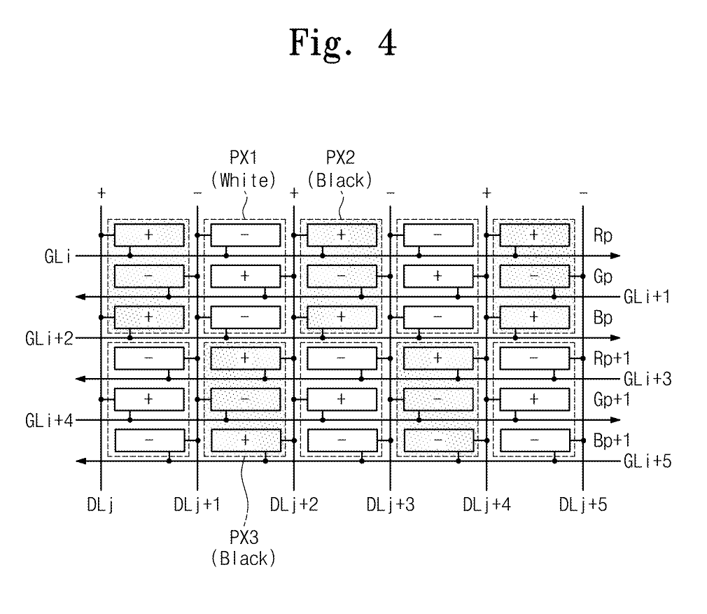

The pattern inspection by the first and second comparators 21 and 22 will be described in more detail below with reference to FIGS. 4 to 6.

The third comparator 23 checks whether a second absolute value of a difference between the data values that are to be applied to the first sub-pixel of a pixel and third sub-pixel of the pixel in the above row, where both sub-pixels are connected to the same data line, is equal to or smaller than a second difference value L.

The second difference value L may be set to a maximum value of the second absolute value that is required to cause the color distortion. In addition, the second difference value L may be defined by a predetermined gray scale value. The second absolute value may be defined by a gray scale difference value between the first and third sub-pixels, which are connected to the same data line. The third comparator 23 outputs the high level signal when the second absolute value is equal to or smaller than the second difference value K.

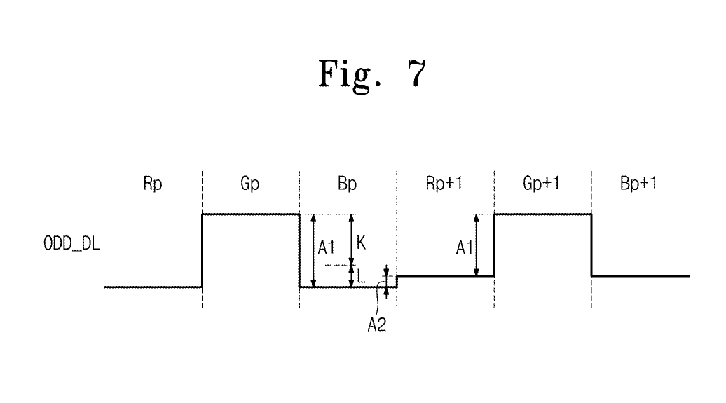

The pattern inspection by the third comparator 23 will be described in more detail below with reference to FIG. 7.

The first, second, and third comparators 21, 22, and 23 output the pattern inspection result of the image signals RGB to the first logic circuit 30. Each of the first, second, and third comparators 21, 22, and 23 output the high level signal when the pattern of the image signals RGB matches the set condition of the comparator, and output the low level signal when the pattern of the image signals RGB does not match the set condition of the comparator.

The first logic circuit 30 includes a three-input AND gate to receive the output signals from the first, second, and third comparators 21, 22, and 23. The first logic circuit 30 outputs a first logic signal in accordance with the output signals of the first, second, and third comparators 21, 22, and 23. In detail, the first logic circuit 30 outputs the first logic signal of the high level when the first, second, and third comparators 21, 22, and 23 output the high level signals. When any one of the first, second, and third comparators 21, 22, and 23 outputs the low level signal, the first logic circuit 30 outputs the first logic circuit of the low level.

The first logic circuit 30 applies the first logic signal to the first and second counters 41 and 42 of the counter 40. Each of the first and second counters 41 and 42 receives the image signals RGB and counts the number of rows and columns of the image signals in response to the first logic signal of the high level from the first logic circuit 30.

The image signals RGB are provided to the pixels through the data lines in the unit of a row in response to the gate signals. When the patterns that cause the color distortion appear in a predetermined area (hereinafter, referred to as a color distortion area) of the display panel 10, the color distortion may be perceived by the viewer.

In more detail, the color distortion area may be, for example, equal to or greater than two-third (⅔) of the area of the display panel 110. For instance, in the case that the color distortion area is equal to or greater than the two-third of the area of the display panel 110 in the row and column directions, the color distortion may be perceived by the viewer.

The image signals RGB are provided to the data driver 160 as the data signals R′G′B′, and the data driver 160 converts the data signals R′G′B′ to the data voltages and outputs the data voltages through the data lines.

The first counter 41 counts the image signals RGB in response to the first logic signal of the high level. That is, the first counter 41 counts the patterns of the image signals RGB, which cause the color distortion, in the unit of column of the data lines.

The first counter 41 outputs a high level signal when the counted value is equal to or greater than a first count value M and outputs a low level signal when the counted value is smaller than the first count value M. Since the color distortion area is equal to or greater than the two-third of the area of the display panel 110, the first count value M may be 2m/3. In other words, in a case in which the total number of the data lines DL1 to DLm is m, the first count value M may be set to two-thirds of the total number (m) of the data lines DL1 to DLm.

The data voltages are sequentially provided to the sub-pixels in the unit of a row at a time in response to the gate signals. The second counter 42 counts the image signals in response to the first logic signal of the high level. That is, the second counter 42 counts the patterns of the image signals RGB, which cause the color distortion, in the unit of a row of the gate lines.

The second counter 42 outputs a high level signal when the counted value is equal to or greater than a second count value N and outputs a low level signal when the counted value is smaller than the second count value N. Because the color distortion area is equal to or greater than two-third of the area of the display panel 110, the second count value N may be 2n/3. In other words, in a case in which the total number of the gate lines GL1 to GLn is n, the second count value N may be set to two-third of the total number (n) of the data lines GL1 to GLn.

The second logic circuit 50 includes a two-input AND gate to receive the output signals from the first and second counters 41 and 42. The second logic circuit 50 outputs a second logic signal in response to the output signals of the first and second counters 41 and 42. In detail, the second logic circuit 50 outputs the second logic signal of the high level when the output signals of the first and second counters 41 and 42 are the high level signal. When any one (or both) of the output signals of the first and second counters 41 and 42 is the low level signal, the second logic circuit 50 outputs the second logic signal of the low level.

The data signal compensator 60 receives the image signals RGB from the external source and outputs the image signals RGB as the data signals R′G′B′.

The data signals R′G′B′ are signals obtained by converting a data format of the image signals RGB to a data format appropriate for an interface between the data driver 160 and timing controller 120. Thus, the data signals R′G′B′ correspond to the image signals RGB, respectively. In addition, conversion of the data format of the image signals RGB may be performed by the data signal compensator 60, or the data signals R′G′B′ may be provided to the data signal compensator 60 after the conversion of the data format of the image signals RGB is performed by a separate circuit (not shown in FIG. 3).

When the high level signal is applied to the data signal compensator 60 from the second logic circuit 50, the data signal compensator 60 compensates for the data signals R′G′B′ and applies the compensated data signals R′G′B′ to the data driver 160. The data signal compensator 60 compensates for the data signals R′G′B′ such that difference values between the common voltage VCOM and the data voltages to be applied to the sub-pixels R, G, and B are the same. That is, because the data driver 160 generates the data voltages corresponding to the data signals R′G′B′, the value of the difference between the common voltage VCOM and each of the data voltages to be applied to the sub-pixels R, G, and B may be the same when the data signal compensator 60 compensates for the data signals R′G′B′.

The data signal compensator 60 does not compensate for the data signals R′G′B′ when the low level signal is applied to the data signal compensator 60 from the second logic circuit 50, and then the data signal compensator 60 provides the data signals R′G′B′ as is to the data driver 160, without the compensation.

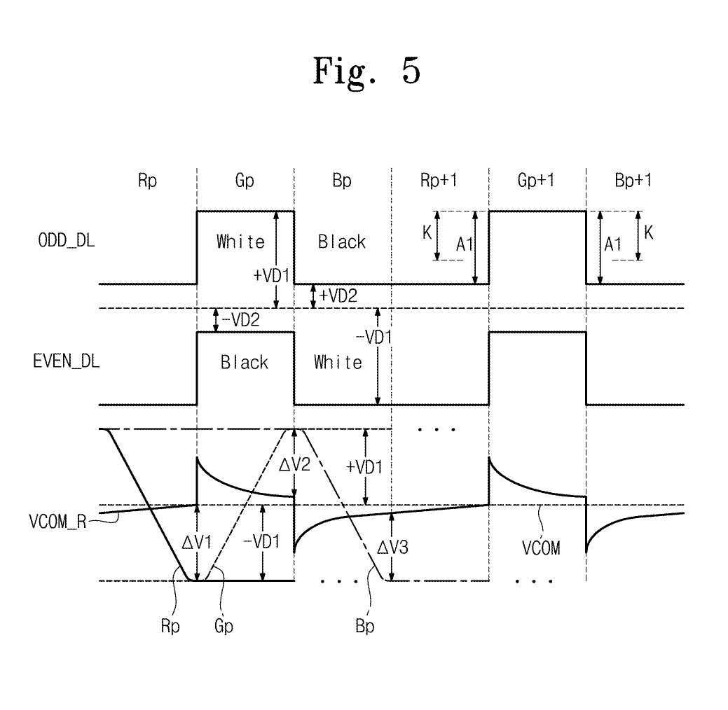

FIG. 4 is a view showing a specific pattern of pixels that causes a color distortion of the display panel shown in FIG. 2, and FIGS. 5 to 7 are timing diagrams explaining a level variation of a common voltage and a color distortion, which are caused by the specific pattern of the pixels shown in FIG. 4.

Referring to FIG. 4, each pixel PX repeatedly displays the white gray scale and the black gray scale in the row and column directions, e.g., a checker pattern. Hereinafter, a first pixel PX1 displaying the white gray scale and a second pixel PX2 displaying the black gray scale will be described in detail with reference to FIGS. 4 to 6.

Referring to FIGS. 4 and 5, the red sub-pixels in rows labeled Rp and Rp+1 that are connected to the odd-numbered data lines DLj, DLj+2, and DLj+4, which are indicated as ODD_DL in FIG. 5, are applied with the data values corresponding to the positive (+) polarity data voltage +VD2 so as to display the black gray scale. The green sub-pixels in rows labeled Gp and Gp+1 that are connected to the odd-numbered data lines DLj, DLj+2, and DLj+4 are applied with the data values corresponding to the positive (+) polarity data voltage +VD1 so as to display the white gray scale. The blue sub-pixels in rows labeled Bp and Bp+1 that are connected to the odd-numbered data lines DLj, DLj+2, and DLj+4 are applied with the data values corresponding to the positive (+) polarity data voltage +VD2 so as to display the black gray scale.

That is, according to the patterns of the data values that are sequentially applied to the odd-numbered data lines ODD DL shown in FIG. 5, the green sub-pixels Gp and Gp+1 display the white gray scale, and the red sub-pixels Rp and Rp+1 and the blue sub-pixels Bp and Bp+1 display the black gray scale.

For instance, the red sub-pixel Rp connected to the first gate line GLi and the odd-numbered data line DLj+2 receives the data value corresponding to the positive (+) polarity data voltage +VD2 in order to display the black gray scale. The green sub-pixel Gp connected to the second gate line GLi+1 and the odd-numbered data line DLj+2 receives the data value corresponding to the positive (+) polarity data voltage +VD1 in order to display the white gray scale. The blue sub-pixel Bp connected to the third gate line GLi+2 and the odd-numbered data line DLj+2 receives the data value corresponding to the positive (+) polarity data voltage +VD2 in order to display the black gray scale.

The positive (+) polarity data voltages +VD 1 and +VD2 have voltage levels that are higher than that of the common voltage VCOM.

The red sub-pixels Rp and Rp+1 connected to the even-numbered data lines DLj+1, DLj+3, and DLj+5, which are indicated by EVEN DL in FIG. 5, are applied with the data values corresponding to the negative (−) polarity data voltage −VD1 so as to display the white gray scale. The green sub-pixels Gp and Gp+1 connected to the even-numbered data lines DLj+1, DLj+3, and DLj+5 are applied with the data values corresponding to the negative (−) polarity data voltage −VD2 so as to display the black gray scale. The blue sub-pixels Bp and Bp+1 connected to the even-numbered data lines DLj+1, DLj+3, and DLj+5 are applied with the data values corresponding to the negative (−) polarity data voltage −VD1 so as to display the white gray scale.

That is, according to the patterns of the data values that are sequentially applied to the even-numbered data lines EVEN_DL shown in FIG. 5, the green sub-pixels Gp and Gp+1 display the black gray scale, and the red sub-pixels Rp and Rp+1 and the blue sub-pixels Bp and Bp+1 display the white gray scale.

For instance, the red sub-pixel Rp connected to the first gate line GLi and the even-numbered data line DLj+1 receives the data value corresponding to the negative (−) polarity data voltage −VD1 in order to display the white gray scale. The green sub-pixel Gp connected to the second gate line GLi+1 and the even-numbered data line DLj+1 receives the data value corresponding to the negative (−) polarity data voltage −VD2 in order to display the black gray scale. The blue sub-pixel Bp connected to the third gate line GLi+2 and the even-numbered data line DLj+1 receives the data value corresponding to the negative (−) polarity data voltage −VD1 in order to display the white gray scale.

The negative (−) polarity data voltages −VD1 and −VD2 have voltage levels that are lower than that of the common voltage VCOM.

Accordingly, the first pixel PX1 is applied with the data voltages to display the white gray scale and the second pixel PX2 is applied with the data voltages to display the black gray scale. As a result, the pixel voltage corresponding to the difference between the common voltage VCOM and the data voltage applied to each pixel is charged in each pixel and the gray scale corresponding to the pixel voltage is displayed in each pixel.

Consequently, as shown in FIG. 5, the pixels have the same pattern as the patterns of the image signals RGB having the checker pattern except that the pixels have opposite polarities to each other.

The common voltage VCOM output from the voltage converter 130 has a uniform level as shown in FIG. 5, but the level of the common voltage VCOM varies due to the coupling between the common voltage and the data voltage, which is generated by the checker pattern. That is, a crosstalk phenomenon occurs from the checker pattern. Thus, the common voltage VCOM output from the voltage converter 130 is changed to a common voltage VCOM _R having a distorted voltage level as shown in FIG. 5. According to the color distortion of the first pixel PX1 displaying the white gray scale, the voltage level of the red sub-pixel Rp of the first pixel PX1 increases to the negative (−) polarity data voltage −VD1. In addition, the voltage level of the green sub-pixel Gp and the blue sub-pixel Bp of the first pixel PX1 increases to the positive (+) polarity data voltage +VD1.

In the case in which the voltage level differences between the common voltage VCOM and each of the sub-pixels Rp, Gp, and Bp of the first pixel PX1 are the same, the white gray scale is normally displayed in the first pixel PX1. However, the common voltage VCOM is changed to the common voltage VCOM _R having the distorted voltage level due to the crosstalk phenomenon. Accordingly, the voltage differences between the common voltage VCOM _R having the distorted voltage level and each of the sub-pixels Rp, Gp, and Bp are different from each other. In such a case, the white gray scale is abnormally displayed in the first pixel PX1.

Hereinafter, the voltage level difference between the common voltage VCOM _R and the data voltage applied to the red sub-pixel Rp is referred to as a first gray scale value ΔV1, the voltage level difference between the common voltage VCOM _R and the data voltage applied to the green sub-pixel Gp is referred to as a second gray scale value ΔV2, and the voltage level difference between the common voltage VCOM _R and the data voltage applied to the blue sub-pixel Bp is referred to as a third gray scale value ΔV3.

In this case, as shown in FIG. 5, the second gray scale value ΔV2 may be substantially the same as the third gray scale value ΔV3, but the first gray scale value ΔV1 is greater than the second and third gray scale values ΔV2 and ΔV3.

The red sub-pixel Rp displays the gray scale corresponding to the first gray scale value ΔV1, the green sub-pixel Gp displays the gray scale corresponding to the second gray scale value ΔV2, and the blue sub-pixel Bp displays the gray scale corresponding to the third gray scale value ΔV3. Therefore, each of the green and blue sub-pixels Gp and Bp displays the gray scale level lower than that of the red sub-pixel Rp. That is, a reddish phenomenon occurs due to the color distortion.

In the case in which the first, second, and third sub-pixels are configured to include the red, green, and blue sub-pixels Rp, Gp, and Bp, respectively, the reddish phenomenon occurs. That is, the color of the pixel tends toward the color of the first sub-pixel among the three sub-pixels by the checker pattern.

The color distortion phenomenon has been described in the case in which the three sub-pixels, i.e., red, green, and blue sub-pixels, are arranged in the direction the data lines extend, but the arrangement of the three sub-pixels may be changed, and thus the color distortion of different colors may be caused.

For instance, when the first, second, and third sub-pixels include the green, blue, and red sub-pixels, respectively, a greenish phenomenon in which the color of the pixel tends toward the green color of the first sub-pixel occurs. In addition, when the first, second, and third sub-pixels include the blue, red, and green sub-pixels, respectively, a bluish phenomenon in which the color of the pixel tends toward the blue color of the first sub-pixel occurs.

According to the color distortion phenomenon, the data values respectively applied to the sub-pixels R, G, and B of each pixel PX have the same value. For example, each of the sub-pixels Rp, Gp, and Bp of the first pixel PX1 is applied with the data voltage to display the white gray scale. Accordingly, the data signals and the image signals, which are applied to the sub-pixels Rp, Gp, and Bp of the first pixel PX1, have values corresponding to the white gray scale.

In addition, each of the sub-pixels Rp, Gp, and Bp of the second pixel PX2 is applied with the data voltage to display the black gray scale. Accordingly, the data signals and the image signals, which are applied to the sub-pixels Rp, Gp, and Bp of the second pixel PX2, have values corresponding to the white gray scale.

For each pixel PX, the first comparator 21 of the timing controller 120 compares the patterns of the image signals RGB with each other, which are to be applied to the sub-pixels a pixel PX, and outputs the compared result. When the data values to be applied to the sub-pixels of a pixel PX are the same, the first comparator 21 outputs the high level signal, and when the data values to be applied to the sub-pixels of a pixel PX are not the same, the first comparator 21 outputs the low level signal.

In detail, the data values to be applied to three sub-pixels R, G, and B of each pixel PX are compared with each other.

For instance, the sub-pixels Rp, Gp, and Bp of the first pixel PX1 display the white gray scale. Accordingly, the data values to be applied to the sub-pixels Rp, Gp, and Rp of the first pixel PX1 are the same, and are the data values which are required to display the white gray scale. In addition the sub-pixels Rp, Gp, and Bp of the second pixel PX2 display the black gray scale. Accordingly, the data values applied to the sub-pixels Rp, Gp, and Rp of the second pixel PX2 are the same, and are the data values which are required to display the black gray scale. In this case, the first comparator 21 outputs the high level signal to the first logic circuit 30 because the data values to be applied to the sub-pixels R, G, and B of a pixel PX are the same.

The second comparator 22 checks whether the first absolute value A1 of the difference between the data values, which are to be applied to the first and second sub-pixels adjacent to each other among the sub-pixels of two adjacent pixels and that are connected to the same data line (that is, sub-pixels from two pixels that are adjacent to each other across the data line between the two pixels, such as, for instance the red pixel Rp from pixel 2 PX2 of FIG. 4 and the green sub-pixel Gp from the first pixel PX1.) is equal to or greater than the first difference value K. In addition, the second comparator 22 checks whether the first absolute value A1 of the difference between the data values, which are to be applied to the second and third sub-pixels adjacent to each other among the sub-pixels of two adjacent pixels and that are connected to the same data line, is equal to or greater than the first difference value K.

For example, the second comparator 22 checks whether the first absolute value A1 of the difference between the data values, which are to be applied to the red and green sub-pixels Rp and Gp adjacent to each other (Rp from second pixel PX2 and Gp from first pixel PX1) or the green and blue sub-pixels Gp and Bp adjacent to each other (Gp from first pixel PX1 and Rp from second pixel PX2) among the sub-pixels connected to the same data line DLj+2, is equal to or greater than the first difference value K.

When the data values for sub-pixels to be applied, for example, to a first pixel PX1 are all the same and the data values to sub-pixels to be applied, for example, to an adjacent pixel such as second pixel PX2 are the same, the first absolute value Al of the difference between the data values, which are to be applied to the first and second sub-pixels adjacent to each other among the sub-pixels of adjacent pixels and that are connected to the same data line DLj+2 is equal, to the first absolute value A1 of the difference between the data values, which are to be applied to the second and third sub-pixels adjacent to each other among the sub-pixels of adjacent pixels and that are connected to the same data line DLj+2. Accordingly, the first absolute values are assigned with the same reference numerals “A1”.

The first difference value K may be set to the minimum value of the first absolute value that is required to cause the color distortion.

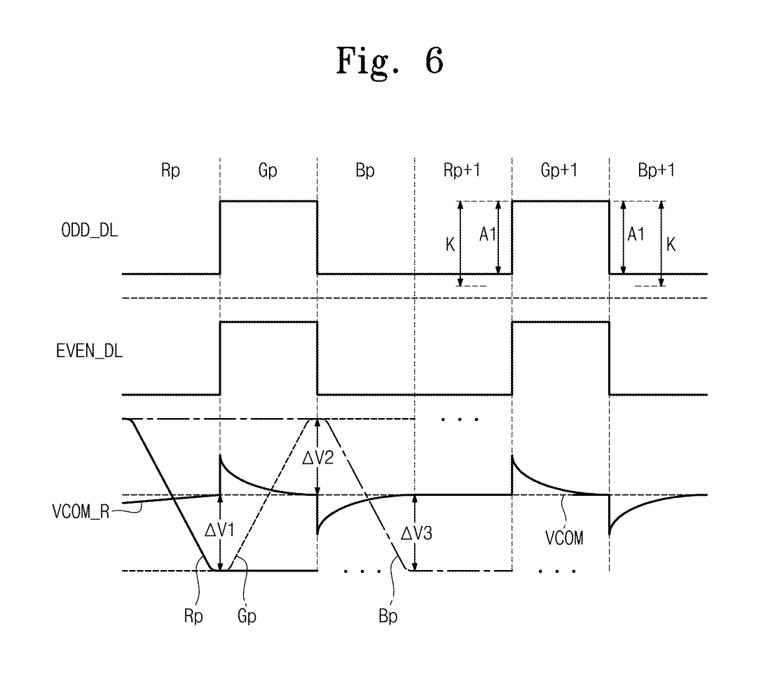

For instance, as shown in FIGS. 5 and 6 the variation of the voltage level of the common voltage VCOM_R may be proportional to the first absolute value A1 of the data values to be applied to the red and green sub-pixels Rp and Gp of adjacent pixels that are connected to the same odd-numbered data line ODD_DL.

Thus, as the first absolute value A1 decreases (FIG. 6), the variation of the voltage level of the common voltage VCOM_R is reduced. When the first absolute value Al of the data values applied to the red and green sub-pixels Rp and Gp is smaller than the first difference value K, the first gray scale value ΔV1, the second gray scale value ΔV2, and the third gray scale value ΔV3 have the same value. When the first gray scale value ΔV1, the second gray scale value ΔV2, and the third gray scale value ΔV3 are the same, the sub-pixels Rp, Gp, and Bp of the first pixel PX1 display the white gray scale normally, thereby preventing distortion of the color. In other words, compensation of the data signals does not need to be performed.

Accordingly, the second comparator 22 checks whether the first absolute value Al is equal to or greater than the first difference value K and outputs the high level signal to the first logic circuit 30 when the first absolute value Al is equal to or greater than the first difference value K.

Hereinafter, the operation of the third comparator 23 will be described with reference to the second pixel PX2 and the third pixel PX3 displaying the black gray shown in FIG. 4.

For the convenience of explanation, the patterns of the data values applied to the odd-numbered data lines ODD DL have been shown in FIG. 7. The patterns of the data values applied to the even-numbered data lines have the same waveform as that shown in FIG. 7 except for the polarities of the patterns.

Referring to FIGS. 4 and 7, the third comparator 23 checks whether the second absolute value A2 of the difference between the data values that are to be applied to the first sub-pixel of a pixel and third sub-pixel of a pixel in the above row, both sub-pixels connected to the same data line, is equal to or smaller than the second difference value L.

For example, the third comparator 23 checks whether the second absolute value A2 of the difference between the data values, which are applied to the red sub-pixel Rp+1 of the third pixel PX3 and the blue sub-pixels Bp of the second pixel PX2 in the row above third pixel PX3, where sub-pixels Rp+1 and Bp are connected to the same data line DLj+2, is equal to or smaller than the second difference value L.

The second difference value L may be set to the maximum value of the second absolute value A2 that is required to cause the color distortion.

As shown in FIG. 7, although the data values applied to the sub-pixels R, G, and B of both pixels PX2 and PX3 are the same, the levels of the data voltages applied to the pixels are different from each other. When the second absolute A2 becomes larger than the second difference value L, the first absolute value Al of the first and second sub-pixels Rp+1 and Gp+1, which are connected to the same data line DLj+2, becomes smaller than the first difference value K. As a result, the color distortion phenomenon may not occur. However, as shown in FIG. 7, when the second absolute value A2 is equal to or smaller than the second difference value L, the first absolute value A1 of the first and second sub-pixels Rp+1 and Gp+1, which are connected to the same data line DLj+2, becomes equal to or greater than the first difference value K.

The second absolute value A2 may have a value corresponding to zero gray scale. Accordingly, the third comparator 23 checks whether the second absolute value A2 is equal to or smaller than the second difference value L and outputs the high level signal to the first logic circuit 30 when the second absolute value A2 is equal to or greater than the second difference value L.

The operation of the first logic circuit 30, the counter 40, the second logic circuit 50, and the data compensator 60 is the same as that of the above-described embodiment.

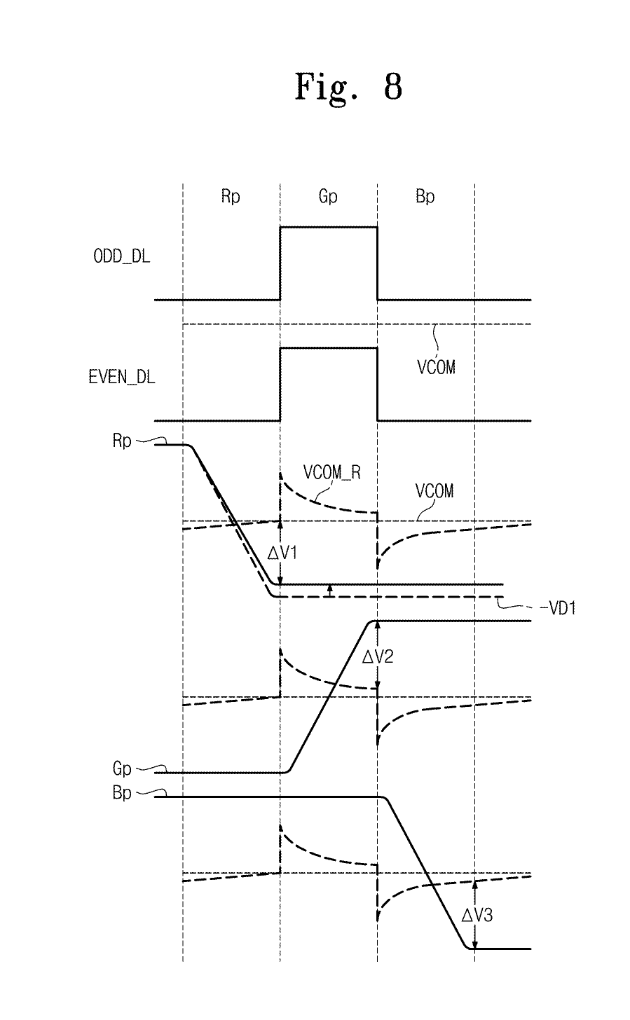

FIG. 8 is a timing diagram showing a voltage level of a pixel applied with a data voltage compensated by a signal compensator shown in FIG. 3.

FIG. 8 shows the voltage levels of the sub-pixels Rp, Gp, and Bp of the first pixel PX1 that displays the white gray scale.

Referring to FIG. 8, the data signal compensator 60 compensates for the data signals corresponding to the data values that may cause the color distortion, in response to the high level signal from the second logic circuit 50. For instance, in the case that the pattern of the image signals RGB matches the pattern condition that causes the reddish phenomenon, the data signal compensator 60 lowers the value of the data signal, e.g., a gray scale value, so as to control the level of the voltage applied to the first sub-pixel Rp.

In detail, when the data signal value is not compensated, the data voltage applied to the red sub-pixel Rp has the negative (−) polarity voltage level −VD1. Thus, the voltage level of the red sub-pixel Rp is decreased to the negative (−) polarity voltage level −VD1.

However, the data signal compensator 60 of the display apparatus 100 controls the data signal value corresponding to the data voltage to be applied to the red sub-pixel Rp such that the first gray scale value ΔV1 becomes equal to the second gray scale value ΔV2 and the third gray scale value ΔV3. That is, the data signal compensator 60 controls the data signal value corresponding to the data voltage to be applied to the red sub-pixel Rp to allow the data voltage applied to the red sub-pixel Rp to have the level higher than that of the negative (−) polarity voltage level −VD 1 and the first gray scale value ΔV1 to be equal to the second gray scale value ΔV2 and the third gray scale value ΔV3.

Accordingly, the red sub-pixel Rp is lowered to a voltage level that is higher than the negative (−) polarity voltage level −VD1, and the first, second, and third gray scale values ΔV1, ΔV2, and ΔV3 have the same value.

In the case that the first sub-pixel is the green sub-pixel Gp, the data signal compensator 60 may control the data signal value corresponding to the data voltage applied to the green sub-pixel Gp such the first, second, and third gray scale values ΔV1, ΔV2, and ΔV3 have the same value.

In addition, in the case that the first sub-pixel is the blue sub-pixel Bp, the data signal compensator 60 may control the data signal value corresponding to the data voltage applied to the blue sub-pixel Bp such the first, second, and third gray scale values ΔV1, ΔV2, and ΔV3 have the same value.

Thus, the first, second, and third gray scale values ΔV1, ΔV2, and ΔV3 have the same value. That is, because the voltage level differences between the common voltage VCOM R and the voltage level of the data voltages applied to the sub-pixels Rp, Gp, and Bp are the same by the data driver 160, each pixel displays the gray scale normally, thereby preventing the occurrence of the color distortion.

Consequently, the display apparatus 100 may improve the color distortion phenomenon by compensating for the data value.

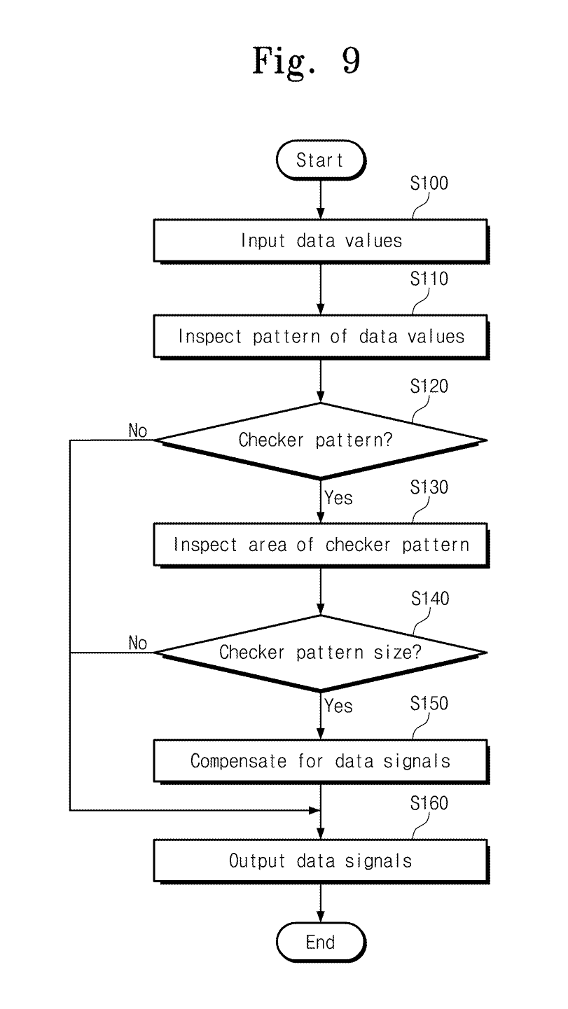

FIG. 9 is a flowchart explaining a method of driving a display apparatus according to an exemplary embodiment.

Referring to FIG. 9, when the data values are provided (S 100), the patterns of the data values are inspected (S110).

In detail, in the step of S110, the data values are inspected to check whether, for each pixel, the data values applied to the sub-pixels of a pixel are the same (hereinafter, referred to as a first condition). In addition, the data values are inspected to check whether the first absolute value A1 of the data values applied to the first and second sub-pixels or the second and third sub-pixels, of adjacent pixels, and that are connected to the same data line, is equal to or larger than the first difference value K (hereinafter, referred to as a second condition). Further, the data values are inspected to check whether the second absolute value A2 of the data values applied to the first sub-pixel of a pixel and third sub-pixel of the pixel in the row above the pixel, and which are connected to the same data line, is equal to or smaller than the second difference value L (hereinafter, referred to as a third condition).

When the first to third conditions are satisfied, the pattern of the data values correspond to a checker pattern in which the white gray scale and the black gray scale are alternately repeated in the row and column directions.

When the pattern of the data values does not correspond to the checker pattern (S120), the data signals are output to generate the data voltages applied to the pixels (S160). In detail, when any one of the first to third conditions is not satisfied (S110), the data signals are output (S160).

When the pattern of the data values corresponds to a checker pattern (S120), the size of the area of the checker pattern is inspected (S130).

In particular, when the first to third conditions are satisfied (S110), the checker pattern area is inspected (S130) to check whether the number of columns of the checker pattern area is equal to or greater than a first count value M (hereinafter, referred to as a fourth condition) and whether the number of rows of the checker pattern area is equal to or greater than a second count value N (hereinafter, referred to as a fifth condition). When any one of the fourth and fifth conditions is not satisfied (S140), the data signals are output (S160).

When the fourth and fifth conditions are satisfied (S140), the data signals used to generated to the data voltages applied to the pixels are compensated (S150). That is, when the number of the columns of the checker pattern is equal to or greater than the first count value M and the number of the rows of the checker pattern is equal to or greater than the second count value N, the data signals used to generated to the data voltages applied to the pixels are compensated (S150).

Then, the compensated data signals are output (S160). Thus, the pixels are applied with the data voltages corresponding to the data signals.

According to the driving method of the display apparatus, when any one of the first to fifth conditions is not satisfied, the data signals are output without being compensated. That is, when the first to fifth conditions match a condition that causes the color distortion, the data signals are compensated and then output so as to prevent the occurrence of the color distortion. However, when the first to fifth conditions do not match the condition that causes the color distortion, the data signals are output without being compensated.

Although the exemplary embodiments have been described, it is understood that the present invention should not be limited to these exemplary embodiments but various changes and modifications can be made by one ordinary skilled in the art within the spirit and scope of the present disclosure including the claims.

What is claimed is:

1. A display apparatus comprising:
a display panel that includes a plurality of pixels arranged in rows by columns, the pixels being connected to a plurality of gate lines and a plurality of data lines crossing the gate lines;
a timing controller that outputs control signals and data signals;
a gate driver that applies gate signals to the pixels through the gate lines in response to the control signals; and
a data driver that receives the data signals and applies data voltages corresponding to the data signals to the pixels through the data lines in response to the control signals,
wherein the timing controller checks whether a pattern of data values provided from an external source corresponds to a checker pattern, in which black and white patterns are alternately repeated in a row direction and a column direction, checks whether an area of the checker pattern is equal to or greater than a predetermined area of the display panel, and compensates for the data signals in accordance with the checked result.

2. The display apparatus of claim 1, wherein each of the pixels comprise a first sub-pixel, a second sub-pixel, and a third sub-pixel, and the first, second, and third sub-pixels are repeatedly arranged in a direction in which the data lines extend.

3. The display apparatus of claim 2, wherein the sub-pixels arranged in odd-numbered rows and connected to odd-numbered gate lines of the gate lines are electrically connected to the data lines disposed at a left side thereof, and the sub-pixels arranged in even-numbered rows and connected to even-numbered gate lines of the gate lines are electrically connected to the data lines disposed at a right side thereof.

4. The display apparatus of claim 3, wherein the data lines alternately receive the data voltages having different polarities from each other and the sub-pixels are driven in a dot-inversion driving scheme.

5. The display apparatus of claim 3, wherein the timing controller comprises:
a pattern comparator that receives the data values and checks the pattern of the data values;
a first logic circuit that outputs a first logic signal in response to the checked result from the pattern comparator when the pattern of the data values corresponds to the checker pattern;
a counter that counts the area of the checker pattern in response to the first logic signal;
a second logic circuit that outputs a second logic signal in response to the counted result from the counter when the area of the checker pattern is equal to or greater than the predetermined area of the display panel; and
a data signal compensator that compensates for the data signals in response to the second logic signal.

6. The display apparatus of claim 5, wherein the pattern comparator comprises:
a first comparator that compares, for each pixel, the data values provided to the sub-pixels in the pixel with each other;
a second comparator that compares a first absolute value of the data values provided to the first sub-pixel of a first pixel and the second sub-pixel of a second pixel adjacent to each other, the first sub-pixel of the first pixel and the second sub-pixel of the second pixel connected to a same data line, or the second sub-pixel of the second pixel and third sub-pixel of the first pixel, the second and third pixels connected to the same data line, with a first difference value; and
a third comparator that compares a second absolute value of the data values provided to a first sub-pixel of a third pixel in a row below and adjacent to the second pixel and the third sub-pixel of the second pixel, the first sub-pixel of the third pixel and the third sub-pixel of the second pixel connected to the same data line, with a second difference value.

7. The display apparatus of claim 6, wherein the first logic circuit comprises a three-input AND gate to respectively receive a compared result from each of the first, second, and third comparators, and the three-input AND gate outputs the first logic signal having a high level in response to the compared results from the first, second, and third comparators when the data values applied to the sub-pixels of each pixel are the same, the first absolute value is equal to or greater than the first difference value, and the second absolute value is equal to or smaller than the second difference value.

8. The display apparatus of claim 6, wherein the first difference value is set to a minimum value of the first absolute value that causes a color distortion, and the second difference value is set to a maximum value of the second absolute value that causes the color distortion.

9. The display apparatus of claim 8, wherein the first absolute value is a gray scale difference value between the first sub-pixel of the first pixel and the second sub-pixel of the second pixel adjacent to each other, the first sub-pixel of the first pixel and the second sub-pixel of the second pixel connected to a same data line, or the second sub-pixel of the second pixel and third sub-pixel of the first pixel, the second and third pixels connected to the same data line.

10. The display apparatus of claim 8, wherein the second absolute value is a gray scale difference value between the first sub-pixel of the third pixel in a row below and adjacent to the second pixel and the third sub-pixel of the second pixel, the first sub-pixel of the third pixel and the third sub-pixel of the second pixel connected to the same data line.

11. The display apparatus of claim 5, wherein the counter comprises:
a first counter that receives the data values and counts a number of rows of the pattern of the data values in response to the first logic signal; and
a second counter that receives the data values and counts a number of columns of the pattern of the data values in response to the first logic signal.

12. The display apparatus of claim 11, wherein the second logic circuit comprises a two-input AND gate to respectively receive a counted result from the first and second counters, and the two-input AND gate outputs the second logic signal having a high level in response to a value of the counted result of each of the first and second counters when the counted value of the row is equal to or greater than M and the counted value of the column is equal to or greater than N.

13. The display apparatus of claim 12, wherein the M corresponds to two-thirds of a number of the data lines and the N corresponds to two-thirds of a number of the gate lines.

14. The display apparatus of claim 5, wherein the sub-pixels receive a common voltage and display a gray scale corresponding to a gray scale value defined by a level difference between the common voltage and the data voltage, and the data signal compensator compensates for the data signals to allow the data values applied to the first, second, and third sub-pixels to be the same.

15. The display apparatus of claim 1, wherein the gate driver comprises:
a first gate driver connected to odd-numbered gate lines of the gate lines and outputs the gate signals in response to the control signals; and
a second gate driver connected to even-numbered gate lines of the gate lines and outputs the gate signals in response to the control signals, and the first and second gate drivers are mounted on both left and right end portions of the display panel and formed in amorphous silicon TFT gate driver circuit.

16. A method of driving a display apparatus comprising a display panel that includes a plurality of pixels arranged in rows by columns, the pixels being connected to a plurality of gate lines and a plurality of data lines crossing the gate lines, the method comprising:
receiving data values;
inspecting a pattern of the data values;
inspecting whether the pattern of the data values corresponds to a checker pattern, in which black and white patterns are alternately repeated in a row direction and a column direction;
measuring an area of the checker pattern;
compensating for data signals used to generate data voltages applied to the pixels when the area of the checker pattern is equal to or greater than a predetermined area of the display panel; and
applying the data voltages corresponding to the compensated data signals to the pixels having the checker pattern through the data lines in response to gate signals provided through the gate lines.

17. The method of claim 16, wherein each of the pixels comprise a first sub-pixel, a second sub-pixel, and a third sub-pixel, the first, second, and third sub-pixels are repeatedly arranged in a direction in which the data lines extend, the sub-pixels arranged in odd-numbered rows and connected to odd-numbered gate lines of the gate lines are electrically connected to the data lines disposed at a left side thereof, and the sub-pixels arranged in even-numbered rows and connected to even-numbered gate lines of the gate lines are electrically connected to the data lines disposed at a right side thereof.

18. The method of claim 17, wherein the inspecting of the pattern of the data values comprising:
comparing, for each pixel, the data values provided to the sub-pixels within a pixel with each other;
comparing a first absolute value of the data values provided to the first sub-pixel of a first pixel and the second sub-pixel of a second pixel adjacent to each other, the first sub-pixel of the first pixel and the second sub-pixel of the second pixel connected to a same data line, or the second sub-pixel of the second pixel and third sub-pixel of the first pixel, the second and third pixels connected to the same data line, with a first difference value; and
comparing a second absolute value of the data values provided to a first sub-pixel of a third pixel in a row below and adjacent to the second pixel and the third sub-pixel of the second pixel, the first sub-pixel of the third pixel and the third sub-pixel of the second pixel connected to the same data line, with a second difference value.

19. The method of claim 18, wherein the first difference value is set to a minimum value of the first absolute value that causes a color distortion, and the second difference value is set to a maximum value of the second absolute value that causes the color distortion.

20. The method of claim 17, wherein the inspecting of the area of the checker pattern comprises counting a number of rows and a number of columns of the pattern of the data values when the data values provided to the sub-pixels of each pixel are the same, the first absolute value is equal to or greater than the first difference value, and the second absolute value is equal to or smaller than the second difference value.

21. The method of claim 20, wherein the compensating of the data signals comprises compensating for the data signals to allow voltage differences between a common voltage applied to the sub-pixels and each of the data voltages applied to the first, second, and third sub-pixels to be equal to each other when the counted value of the row is equal to or greater than M and the counted value of the column is equal to or greater than N.

22. The method of claim 21, wherein the M corresponds to two-thirds of a number of the data lines and the N corresponds to two-thirds of a number of the gate lines.
